(19) United States
(12) Patent Application Publication
(10) Pub. No.: US 2017/0230706 A1
(43) Pub. Date: Aug. 10, 2017

(54) DOWNLOADING OF MEDIA BASED ON DELETION OF A CONSUMED EPISODE OF THE SAME SHOW

(71) Applicant: THOMSON LICENSING, Issy Les Moulineaux (FR)

(72) Inventors: Travis ROGERS, Santa Monica, CA (US); Arnaud RETUREAU, West Hollywood, CA (US)

(73) Assignee: THOMSON LICENSING, Issy Les Moulineaux (FR)

(21) Appl. No.: 15/518,529

(22) PCT Filed: Jul. 28, 2015
(86) PCT No.: PCT/US15/42399

§ 371 Date: Apr. 12, 2017

Related U.S. Application Data
(60) Provisional application No. 62/068,899, filed on Oct. 27, 2014.

(51) Int. Cl. H04N 21/4335; H04N 21/472; H04N 21/61; H04N 21/4147; H04N 21/442

(52) U.S. Cl. CPC H04N 21/4335; H04N 21/4147; H04N 21/44204; H04N 21/6125; H04N 21/47217

(57) ABSTRACT

The present principles of the embodiments generally relate to an apparatus and a method for downloading of media content and particularly for downloading a plurality of episodes for a show such as e.g., a television series. In one exemplary embodiment, if sufficient space is not available for the selected plurality of episodes of the show, then at least one already downloaded and watched episode of same show is deleted. Another episode not yet downloaded will then be downloaded to fill a space vacated by the deleted downloaded and watched episode of the same show.

### BACKGROUND OF THE INVENTION

Field of the Invention

The present principles of the embodiments generally relate to an apparatus and a method for downloading of media content and particularly for downloading a plurality of episodes for a show such as e.g., a television series. In one exemplary embodiment, if sufficient space is not available for the selected plurality of episodes of the show, then at least one already downloaded and watched episode of same show is deleted. Another episode not yet downloaded will then be downloaded to fill a space vacated by the deleted downloaded and watched episode of the same show.

Background Information

Presently, many media asset providers or websites such as M-Go, Netflix, Amazon, and the like, release a “season” of a show (e.g., a television series such as “Veep” on HBO, “Orange is the New Black” on Netflix, and etc.) on the same day when all of the episodes of a particular season of the show are made available at the same time.

With the habits of users performing “binge” consumption, some users may want to receive all of the episodes of a particular media asset or a show at the same time. The downloaded episodes can then be stored on their devices for later viewing (compared to having all of the episodes of a media asset streamed from a server). However, different user devices have different capabilities. For example, a user device may not have enough storage capacity to store all of the episodes for one or multiple seasons of a particular show, and/or that a user device may take too long to download all the user selected episodes at once.

### SUMMARY OF THE INVENTION

The present inventors recognize the need to improve the existing systems and methods for downloading media assets and in particular, downloading of multiple episodes of a show, in order to accommodate different user devices and/or different user consumption behaviors.

In accordance with an aspect of the present invention, an apparatus is presented, comprising:
a user input for selecting a plurality of episodes of a show for download from a server; and
a processor configured to determine if there is sufficient space in a storage device for the selected plurality of episodes of the show; wherein the processor is configured to download the selected plurality of the show if there is sufficient space; and if there is no sufficient space, then the processor is configured to delete at least one downloaded and watched episode of same show from the storage device, and download at least one episode of the selected plurality of episodes not yet downloaded to fill a space vacated by the deleted at least one downloaded and watched episode of the same show.

In another exemplary embodiment, a method for use in a user device is presented, comprising:
selecting a plurality of episodes of a show for download from a server;
determining if there is sufficient space in a storage device for the selected plurality of episodes of the show;
downloading the selected plurality of episodes of the show if there is sufficient space as determined by the determining step; and
if sufficient space is not available for the selected plurality of episodes of the show as determined by the determining step, then deleting at least one downloaded and watched episode of same show from the storage device, and downloading at least one episode of the selected plurality of episodes not yet downloaded to fill a space vacated by the deleted at least one downloaded and watched episode of the same show.

In another exemplary embodiment, a method for use on a website for downloading episodes of a show to a user device is presented, comprising:
determining a plurality of episodes of a show to be downloaded in response to a user request from the user device;
determining if there is sufficient space in a storage device for the selected plurality of episodes of the show;
downloading to the user device the selected plurality of episodes of the show if there is sufficient space as determined by the determining step; and
if sufficient space is not available for the selected plurality of episodes of the show as determined by the determining step, then instructing the user device to delete at least one downloaded and watched episode of same show from the storage device, and downloading at least one episode of the selected plurality of episodes not yet downloaded to fill a space vacated by the deleted at least one downloaded and watched episode of the same show.

In another exemplary embodiment, a computer program product stored in non-transitory computer-readable storage media comprising computer-executable instructions is presented for:
selecting a plurality of episodes of a show for download from a server;
determining if there is sufficient space in a storage device for the selected plurality of episodes of the show;
downloading the selected plurality of episodes of the show if there is sufficient space as determined by the determining step; and
if sufficient space is not available for the selected plurality of episodes of the show as determined by the determining step, then deleting at least one downloaded and watched episode of same show from the storage device, and downloading at least one episode of the selected plurality of episodes not yet downloaded to fill a space vacated by the deleted at least one downloaded and watched episode of the same show.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

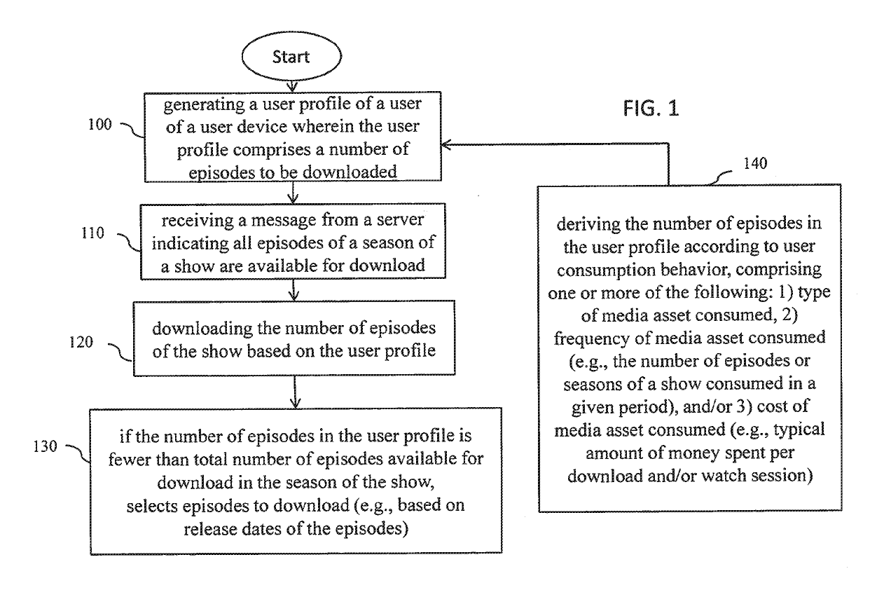

FIG. 1 shows an exemplary process according to the principles of the present invention;

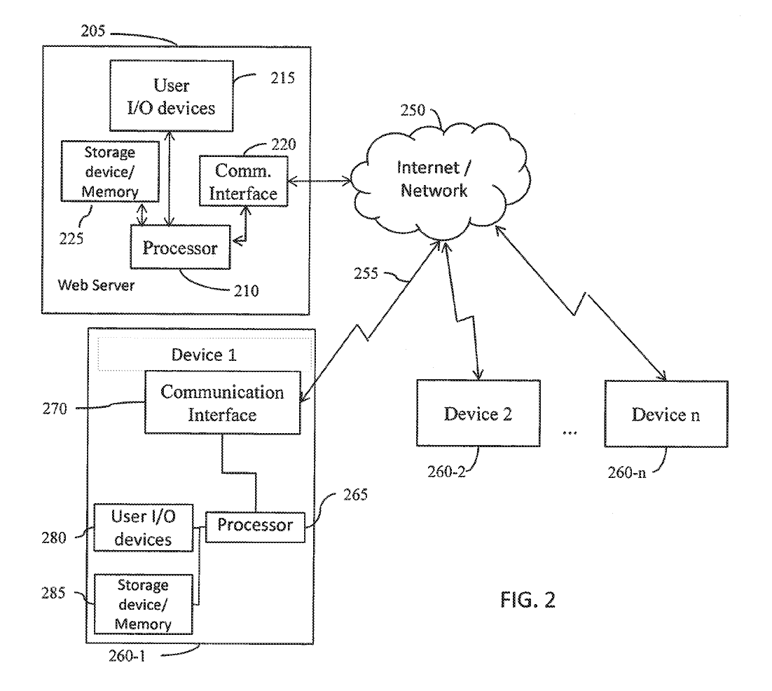

FIG. 2 shows an example system according to the principles of the present invention;

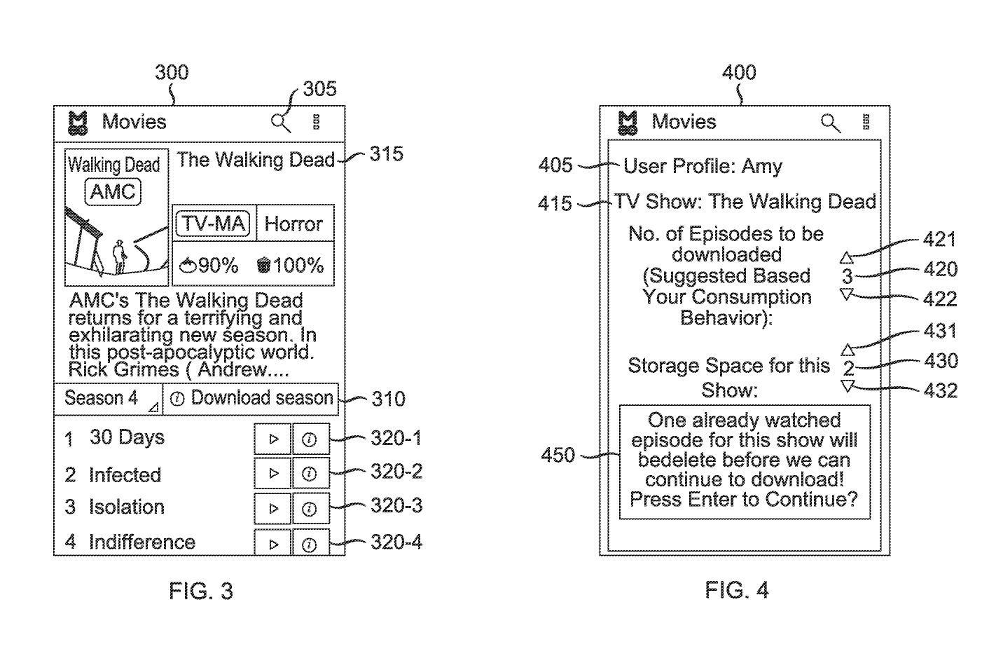

FIGS. 3 and 4 show exemplary user interfaces and interactions according to the principles of the present invention; and

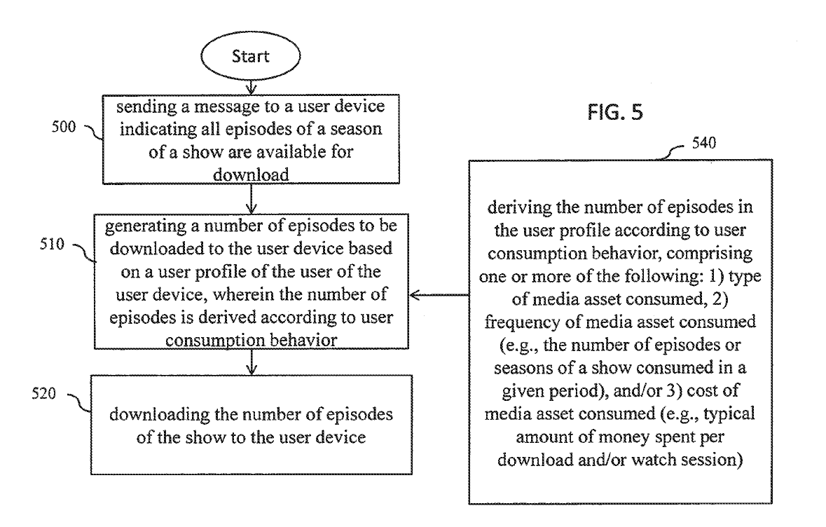

FIGS. 5 to 7 show exemplary processes according to the principles of the present invention.

The examples set out herein illustrate exemplary embodiments of the invention. Such examples are not to be construed as limiting the scope of the invention in any manner.

### DETAILED DESCRIPTION

FIG. 2 is an exemplary system according to the principles of the present invention. FIG. 2 illustrates, e.g., a system capable of providing downloading of media assets such as, but not limited to, one or more episodes of a show, from a web server 205 to a plurality of exemplary end user devices 260-1 to 260-n. As noted above, a show may be, for example, a television series such as “Veep” on HBO, “Orange is the new Black” on Netflix, and etc. In addition, web server 250 also provides relevant web pages to interact with a user, in connection with the downloading of media content to user devices 260-1 to 260-n.

Exemplary user devices 260-1 to 260-n in FIG. 2 may access media assets and web pages over a communication network 250. The communication network 250 may comprise, for example, one or more of wide area networks (WANs) and/or local area networks (LANs), interconnected with Internet, as needed.

Web server 205 may be a computer having a processor 210 such as, e.g., an Intel processor, running an appropriate operating system such as, but not limited to, Windows 2008 R2, Windows Server 2012, Linux operating system, and etc. Devices 260-1 to 260-n may access different media assets and web pages provided by server 205 using, e.g., HTTP protocol. A well-known web server hosting application software is Apache HTTP Server software available from http://www.apache.org.

As noted before, web server 205 may also provide media content services similar to, e.g., Amazon.com, Netflix, or M-GO. Web server 205 may use a streaming protocol such as but not limited to, Apple HTTP Live Streaming (HLS) protocol, Adobe Real-Time Messaging Protocol (RTMP), Microsoft Silverlight Smooth Streaming Transport Protocol, and etc., to transmit or download various media assets such as, but not limited to, video programs, audio programs, movies, TV shows, software, games, electronic books, electronic magazines, electronic articles, and etc., to one or more of the end-user devices 260-1 to 260-n for purchase or consumption by a user.

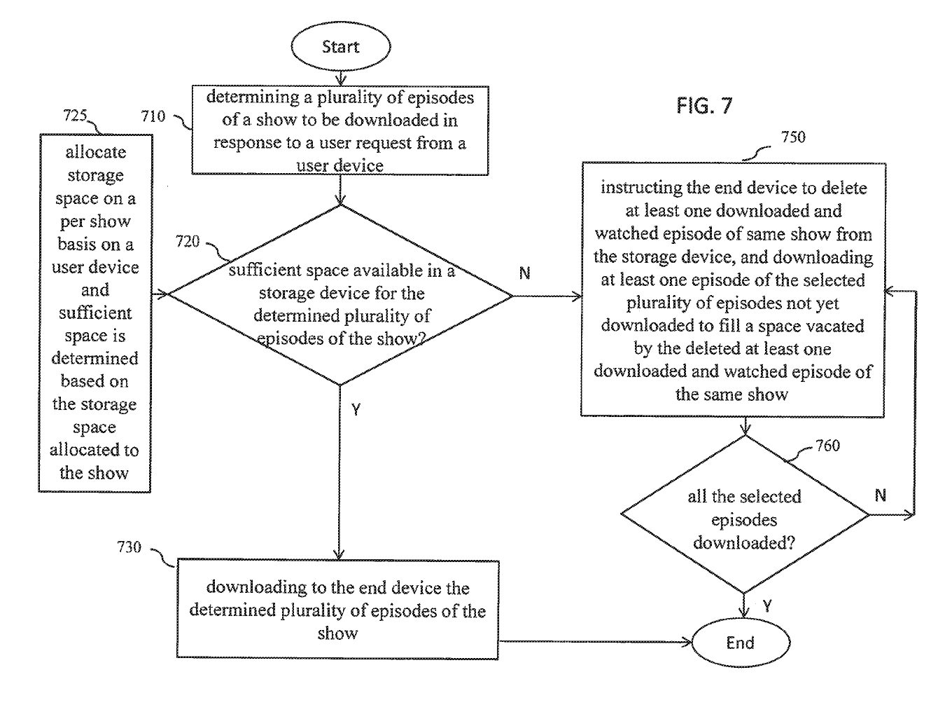

In addition, a user such as a web server administrator may interact with and configure web server 205 using user input/output devices 215 (e.g., a keyboard and/or a display, etc.), as well known in the art. Furthermore, various web pages, media assets and their associated metadata may be stored in a database residing on a storage device/memory 225 and accessed by processor 210 as needed. Storage device/memory 225 may comprise, e.g., one or more hard drives and/or other suitable memory devices, as well known in the art. A computer program product may be stored in storage device/memory 225 which may represent one or more non-transitory computer-readable storage media comprising computer-executable instructions that will be described later in connection with FIG. 5 and FIG. 7. Memory 225 may also represent Random Access Memory (RAM) which is used for execution of the computer instructions in conjunction with processor 265, as well known in the art.

Server 205 is connected, through a communication interface 220, to communication network 250 as described above, for communicating with other web sites (not shown) and to one or more user devices 260-1 to 260-n, as shown in FIG. 2. In addition, one skilled in the art would readily recognize that other server components, such as, but not limited to, a power supply, a cooling fan, etc., may also be needed by server 205, but are not shown in FIG. 2 to simplify the drawing.

Exemplary user devices 260-1 to 260-n shown in FIG. 2 may comprise one or more of, e.g., PCs, laptops, tablets, cellphones, digital video recorders, and etc. One of such devices may be, e.g., a Microsoft Windows 7 or Windows 8 computer or tablet, an Android phone (e.g., Samsung S3, S4, or S5), an Apple IOS phone (e.g., IPhone 6), or an Apple IPad. An exemplary block diagram of an exemplary device according to the principles of the present invention is illustrated in block 260-1 of FIG. 2 and will be described in detail below.

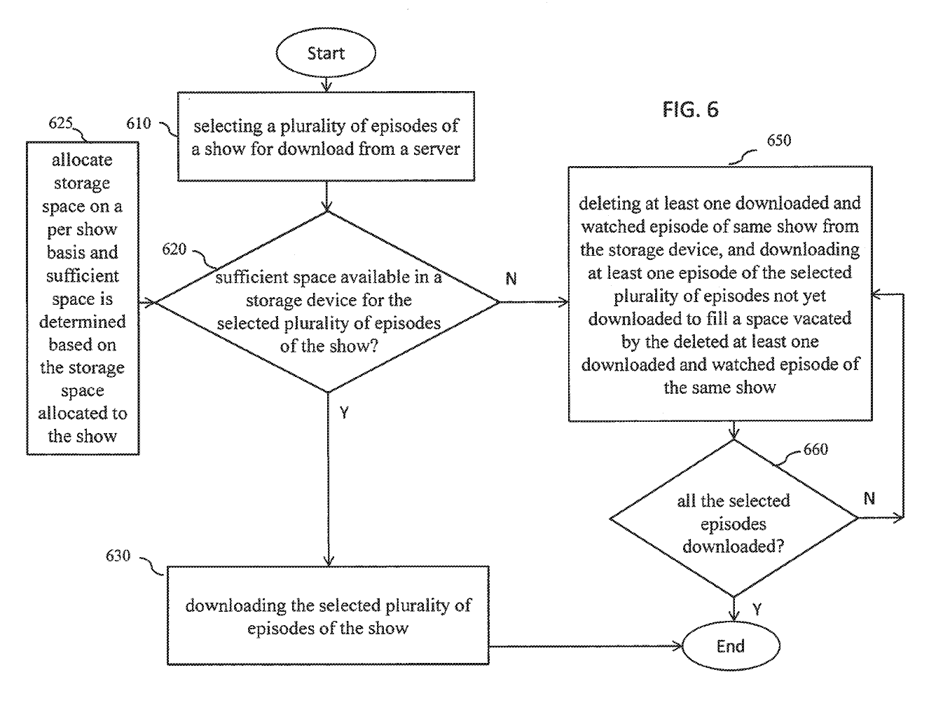

Exemplary user device 260-1 comprises a processor 265 for processing various data and for controlling various functions and components of the user device 260-1. In addition, device 260-1 also comprises user input/output devices 280 which may include, e.g., a touch and/or a physical keyboard for inputting user data, and/or a display and/or a speaker for outputting visual and/or audio user data and feedback. Device 260-1 also comprises a storage device/memory 285 for processing and storing different files and information as necessary, including web pages and downloaded media content, and relevant metadata information. Storage device/memory 225 may also represent, e.g., one or more non-transitory computer-readable storage media comprising computer-executable instructions that will be described later in connection with, e.g., FIG. 1 and FIG. 6. Memory 285 may also represent Random Access Memory (RAM) which is used for execution of the computer instructions, as well known in the art.

Device 260-1 also comprises a communication interface 270 for connecting and communicating to/from web server 205 and other web sites (not shown) and devices, via, e.g., a communication network 250, using one or more of e.g., a cable network, a FIOS network, a Wi-Fi network, and/or a cellphone network (e.g., 3G, 4G, LTE), and etc., available to the end user device.

FIG. 3 and FIG. 4 illustrate exemplary user interface screens and user interaction functions according to the principles of the present invention. These user interface screens and functions may be controlled and/or provided by e.g., processor 265 in device 260-1 of FIG. 4 and/or processor 210 in web server 205.

As shown in FIG. 3, a user interface screen 300 provides a user with the ability to search for a media asset with a search bar 305. Once a show such as e.g., “The Walking Dead” 315 is found, screen 300 allows a user to select either downloading all of the episodes of a season by selecting icon “Download season” 310, or by selecting individual downloading arrow icons 320-1 to 320-4, each corresponding a respective individual episode of the show as shown in FIG. 3. Although not shown in FIG. 3, a user can also specify to download more than 1 season of episodes, or any other season or seasons of episodes, if other seasons or more episodes are available for download for a selected show other than that shown in FIG. 3.

Turning back to FIG. 1, FIG. 1 is a flow chart of an exemplary process according to principles of the present invention. In one exemplary embodiment, the exemplary process in FIG. 1 may be implemented as computer executable instructions which may be executed by, e.g., processor 265 in device 260-1. For example, a computer program product having the computer-executable instructions may be stored in non-transitory computer-readable storage media 285 of device 260-1.

The exemplary control program shown in FIG. 1, when executed, facilitates processing and displaying of user interfaces screens shown, for example, in FIG. 3 and FIG. 4, and controls respective functions of an exemplary device 260-1 shown in FIG. 2. One skilled in the art can readily recognize that the exemplary process shown in FIG. 1 may also be implemented using a combination of hardware and software (e.g., a firmware implementation), and/or executed using logic arrays or ASIC.

At step 100 of FIG. 1, a user profile 405 of a user (e.g., “Amy”) of a user device (e.g., device 260-1 of FIG. 2) is generated as shown on an exemplary screen 400 of FIG. 4. In one exemplary embodiment, a user profile 405 comprises a number of episodes 420 to be downloaded for a selected show 415 “The Walking Dead.” As shown in FIG. 4, the number of episodes 420 is “3” for the exemplary embodiment.

At step 110 of FIG. 1, a message from, e.g., a web server 205 in FIG. 2, indicating that all episodes of a season of a show are available for download is received by a user device 260-1. In one exemplary embodiment, the message may be embedded in, e.g., HTTP protocol and may be able to be displayed on user device 260-1 as shown, e.g., as element 310 of in FIG. 3. Alternatively, this message may be a separate data communication message using a different protocol for allowing correct operations of server 205 in connection with a user device 260-1 of FIG. 2.

At step 120 of FIG. 1, the number of episodes of the show based on the user profile as shown in FIG. 4, will be downloaded by the user device 260-1. As illustrated in FIG. 4, since the number of episodes 420 is “3” in the user profile, 3 episodes will be targeted to be downloaded.

At step 130 of FIG. 1, if the number of episodes 410 (e.g., “3”) in the user profile as shown, e.g., in FIG. 4, is fewer than total number of episodes available for download in the season of the show (e.g., 4 episodes shown in FIG. 3), the user is then prompted to select the fewer number of episodes to be download. The selection of the fewer episodes may be made, for example, by selecting the respective downloading arrows 320-1 to 320-4 of FIG. 3. The selection can also be made by other exemplary alternatives, such as, e.g., by release dates of the available episodes such that, e.g., the newest or the oldest 3 episodes of a show are selected. In one embodiment, the processor 265 is operative or configured to limit the selection to only the number of episodes as specified in the user profile. In another embodiment, the processor 265 is operative or configured to receive the message indicating that all episodes of a season of a show are available for download, and in response, automatically select a number of episodes according to the number specified in the user profile and download the selected episodes. The processor 265 automatically selects episodes for download according to a rule, such as the newest episodes, the oldest episodes, or in a random manner.

In one embodiment, the user profile also includes a period and the number of episodes is associated with the period. As such, the user can download the number of episodes per the period as specified in the user profile.

In one embodiment, the system for downloading episodes of a show can be configured to download episodes in accordance with consumption habit or behavior of a user. A user profile can be generated for a user where a system learns about how a user download and/or watch a particular media asset. For example, based on the prior consumption habits of a user, a system determines that a user typically watches 3 episodes of a particular media asset every week or weekend based on prior consumption data. The system would therefore automatically download 3 episodes of a media asset at a time, as shown, e.g., in element 420 of FIG. 4. This can be contrasted against a user who tends to consume all the episodes of a particular show in one day when such episodes become available. In this case, the system would end up downloading all of the episodes of a particular media title at once because of the user profile.

In one embodiment, the processor 265 in the user device 260-1 is operative or configured to learn the user habit and update the number in the user profile. In another embodiment, the processor 210 in the web server 205 is operative or configured to learn the user habit of the user of the user device 260-1 in downloading content from the web server 205 and request the processor 265 to update the number in the user profile accordingly.

Therefore, as shown at step 140 of FIG. 1, the number of episodes (e.g., “3”) in the user profile 405 as shown in FIG. 4 may be derived according to user consumption behavior. User consumption as used herewith may comprise a user having downloaded a media asset, or watched a media asset, or both. Therefore, the user consumption behavior may comprise one or more of the following watching and/or downloading factors: 1) type of media asset consumed, 2) frequency of media asset consumed (e.g., the number of episodes or seasons of a show consumed in a given period), and/or 3) cost of media asset consumed (e.g., typical amount of money spent per download and/or watch session for a user).

In one exemplary embodiment as shown in FIG. 4, this derived or suggested number of episodes 420, based on user consumption behavior in user profile 405, may be additionally adjusted manually or overridden by a user. For example, the user may increment or decrement this derived or suggested number of episodes 420 by selection either an up arrow 421 or a down arrow 422 respectively in FIG. 4.

In one embodiment, the learning of the user habit is not based on a particular show. Rather, the learning is based on downloading habit of episodes from different shows. The observed period and number of episodes for download in the observed period stored in the user profile may be the average of the periods and numbers of episodes collected from different shows in a predefined period, for example, a year. As such, unlike as illustrated in FIG. 4, the number of episode is not associated with a particular show and is applicable for all shows.

In one embodiment, after step 130 is executed and the if there are episodes of the show have not been downloaded, the processor 265 is operative or configured to download a number of episodes not yet downloaded according to the number specified in the user profile after the period stored in the user profile has elapsed, and the process continues until all the episodes in the show have been downloaded. In effect, the processor 265 is operative or configured to repeat the downloading step for every specified period until all the episodes in the show have been downloaded.

In another exemplary embodiment, a method for use by a website for downloading media content to a user device is shown in a process diagram of FIG. 5, and may be executed by processor 210 of web server 205 of FIG. 2. The process shown in FIG. 5 may represent, e.g., a computer program product having the computer-executable instructions which may be stored in non-transitory computer-readable storage media 225 of web server 205, as described before.

At step 500 of FIG. 5, a message is sent by web server 205 to user device 260-1 in FIG. 2, indicating that all episodes of a season of a show are available for download. As already noted above, in one exemplary embodiment, the message may be embedded in, e.g., HTTP protocol and may be able to be displayed on user device 260-1 as shown in element 310 of FIG. 3. Alternatively, this message may be a separate data communication message using a different protocol to allow correct operations of server 205 with user device 260-1 of FIG. 2.

At step 510 of FIG. 5, a number of episodes 420 (e.g., “3”) to be downloaded to the user device is generated based on a user profile 405 of the user (e.g., “Amy”) of the user device, as shown in FIG. 4. The number of episodes is derived according to user consumption behavior at step 540 (similar to what has been described before in connection with step 140 of FIG. 1). In one embodiment, the processor 210 is operative or configured to learn the user habit of downloading content from the user device 260-1 and/or determine a period and a number of episodes to be downloaded in the period at step 540. In another embodiment, the processor 210 is operative or configured to generate the number and/or period information by receiving the information from the processor 265 in the user device 260-1

At step 520 of FIG. 5, the web server 205 of FIG. 2 then causes the downloading of the number of episodes of the show (generated in step 510 previously) to the user device. In one embodiment, the processor 210 is operative and configured to download the generated episodes by pushing the generated episode to the user device 260-1.

As discussed above with respect to FIG. 1, the user profile may also specify a period for download a number of episodes as specified in the user profile, so that the user can only download a number of episodes specified in the user profile per the specified period and the processor 210 is operative or configured to repeat step 520 and/or step 510 until all the episodes in the show have been downloaded.

In an exemplary embodiment, when a user selects to download, e.g., a plurality of a show or a complete season of a show, it is possible that the user's device will not have enough storage space to store all of the selected episodes. Therefore, according to the principles of the present invention, an exemplary downloading mechanism may be implemented by deleting one or more of the already downloaded and watched episodes of the same show on the storage device. Therefore, episodes for a whole season may be downloaded this way as storage space becomes available on a device. In one embodiment, this “invisible” queuing feature is accomplished automatically without a user necessarily being notified about this partial download.

Accordingly, FIG. 6 illustrates this exemplary downloading process according to the principles of the present invention. The process shown in FIG. 6 may be executed by, e.g., processor 265 of device 260-1 of FIG. 2. The process shown in FIG. 6 may represent, e.g., a computer program product having the computer-executable instructions which may be stored in non-transitory computer-readable storage media 285 of user device 260-1.

At step 610 of FIG. 6, multiple episodes of a show are selected by a user device (e.g., 260-1 of FIG. 2) for download from a server (e.g., web server 205 of FIG. 2). The selection can be done by the processor 265 automatically without user intervention or according to user input. Again the number of the episodes selected for download may be determined based on a user profile as described previously in connection with e.g., FIG. 1.

At step 620, a determination is made to see if there is sufficient space in a storage device for the selected plurality of episodes of the show, as selected in step 610. At step 630, if there is sufficient space as determined by the determining step of 620, then the selected plurality of episodes of the show will be downloaded.

If, on the other hand, sufficient space is not available for the selected plurality of episodes of the show to be downloaded as determined by the determining step of 620, then at least one downloaded and watched episode of same show from the storage device is deleted, and one episode of the selected plurality of episodes not yet downloaded is downloaded to fill a space vacated by the deleted at least one downloaded and watched episode of the same show at step 650. In an exemplary embodiment, the deleting and downloading at step 650 are automatically performed by the user device without user intervention.

In one exemplary embodiment, before performing the step of deleting the at least one downloaded and watched episode of the same show at step 650, a delete notification is given to the user to warn the user of the deletion. This is illustrated in FIG. 4 where a deletion notification 450 is given to a user. In addition, a query is also shown asking the user to press “Enter” to confirm the deletion. If the user presses “Enter”, then the at least one downloaded and watched episode will be deleted at step 650. On the other hand, if the user does not press “Enter”, then no downloaded and watched episode will be deleted, and the subsequent downloading of one or more of the selected episodes will be skipped and paused.

At step 660 of FIG. 6, a determination is made to see if all of the selected episodes have been successfully downloaded. If the determination is yes, then the process of FIG. 6 ends. If on the other hand, the determination is no, then step 650 of deleting and downloading are repeated, as necessary.

In one embodiment, if the user profile specifies a number of episodes can be downloaded in a specified period, when the process ends, the processor 265 is operative or configured to repeat the process except step 625 in FIG. 6 after the specified period has been elapsed until all the episodes in the show have been downloaded.

In one exemplary embodiment according to the principles of the present invention, a storage space of a storage device is allocated on a per show basis and whether there is the sufficient space is determined at step 620 of FIG. 6 based on the storage space allocated to the selected show, as shown at step 625 of FIG. 6. This per show storage allocation may be made automatically, or first by a default allocation for the selected show (e.g., may be based on consumption behavior) and then the allocation is capable of being overridden manually by a user of the device.

One exemplary embodiment according to this aspect of the present invention is shown in FIG. 4. FIG. 4 shows a default storage space allocation of “2” (i.e., element 430) for the TV show “The Walking Dead” 415. Depending on a specific implementation, the number “2” for element 430 may represent, e.g., number of episodes, number of hours, number of Giga Bytes of storage, and etc. A user can then either increment or decrement this default number 430 by selecting respectively an up arrow 431 or a down arrow 432 in FIG. 4.

FIG. 7 shows another exemplary process for use by a website for downloading media content to a user device. The process shown by FIG. 7 may be executed by processor 210 of web server 205 of FIG. 2. The process shown in FIG. 7 may represent, e.g., a computer program product having the computer-executable instructions which may be stored in non-transitory computer-readable storage media 225 of web server 205 of FIG. 2, as described before.

At step 710 of FIG. 7, multiple episodes of a show to be downloaded to a user device (e.g., 260-1 of FIG. 2) are selected in response to a user request from the user device. Again, the number of the episodes selected for download may be determined based on a user profile as described previously.

At step 720, a determination is made to see if there is sufficient space in a storage device for the selected plurality of episodes of the show. In one embodiment, the processor 210 in the web server 205 is operative or configured to request the processor 265 in the user device 260-1 to provide the storage information. At step 730, if there is sufficient space as determined by the determining step of 720, then the determined plurality of episodes of the show will be downloaded to the user device (e.g., 260-1 of FIG. 2). Again, in one exemplary embodiment according to the principles of the present invention, a storage space of a storage device is allocated on a per show basis and whether there is the sufficient space as determined at step 720 of FIG. 7 is based on the storage space allocated to the selected show, as shown at step 725 of FIG. 7.

If on the other hand, sufficient space is not available for the determined plurality of episodes of the show to be downloaded as determined by the determining step of 720, then at step 750, web server (e.g., web server 205 of FIG. 2) will instruct the user device to delete at least one downloaded and watched episode of same show from a storage device, and one episode of the selected plurality of episodes not yet downloaded will be downloaded by the web server to fill a space vacated by the deleted at least one downloaded and watched episode of the same show. In an exemplary embodiment, the deleting and downloading at step 750 are automatically performed by the web server without user intervention.

At step 760 of FIG. 7, a determination is made to see if all of the selected episodes have been successfully downloaded. If the determination is yes, then the process of FIG. 7 ends. If on the other hand, the determination is no, then step 750 is repeated.

In one embodiment, if the user profile specifies a number of episodes can be downloaded in a specified period, when the process ends, the processor 210 is operative or configured to repeat the process except step 725 in FIG. 7 after the specified period has been elapsed until all the episodes in the show have been downloaded.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all components, parameters, dimensions, materials, and configurations described herein are meant to be exemplary and that the actual components, parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments.

1. A method for use in a user device, the method comprising:
selecting a plurality of episodes of a show for download from a server;
determining if there is sufficient space in a storage device for the selected plurality of episodes of the show;
and
if sufficient space is not available for the selected plurality of episodes of the show as determined by the determining, then deleting at least one downloaded and consumed episode of same show from the storage device, and downloading at least one episode of the selected plurality of episodes not yet downloaded.

2. The method of claim 1, wherein a storage space of the storage device is allocated on a per show basis and the sufficient space is determined based on the storage space allocated to the show.

3. The method of claim 2 further comprises repeating deleting and downloading if sufficient space is not available as determined by the determining, until all the selected plurality of episodes of the show have been downloaded.

4. The method of claim 1, wherein the deleting and downloading if sufficient space is not available as determined by the determining, are automatically performed by the user device without user intervention.

5. The method of claim 1, further comprising notifying a user before deleting the at least one downloaded and consumed episode of the same show.

6. The method of claim 5, wherein the notifying further comprises
providing a query to the user of whether to delete the at least one downloaded and consumed episode; and
downloading the at least one episode of the selected plurality of episodes not yet downloaded if a user response to the query is yes.

7. The method of claim 6 further comprising:
If the user response to the query is no, then skipping the downloading of the at least one episode of the selected plurality of episodes not yet downloaded.

8. The method of claim 1, further comprising determining a number of episodes of the show to be downloaded based on a user profile.

9. The method of claim 8, wherein the number of the episodes to be downloaded is determined in response to a message from the server indicating that all episodes of the show are available for download.

10. The method of claim 9 wherein the all episodes of the show correspond to a season of the show.

11. An apparatus comprising:
a user input for selecting a plurality of episodes of a show for download from a server; and
a processor configured to determine if there is sufficient space in a storage device for the selected plurality of episodes of the show; wherein the processor is configured to, if there is no sufficient space, delete at least one downloaded and consumed episode of same show from the storage device, and download at least one episode of the selected plurality of episodes not yet downloaded.

12. The apparatus of claim 11, wherein a storage space of the storage device is allocated on a per show basis and the sufficient space is determined based on the storage space allocated to the show.

13. The apparatus of claim 12 wherein the processor is further configured to delete another downloaded and consumed episode of the same show and download another episode of the selected plurality of episodes not yet downloaded until all the selected plurality of episodes of the show have been downloaded.

14. The apparatus of claim 11, wherein the processor is further configured to provide a notice to a user before deleting the at least one downloaded and consumed episode of the same show.

15. The apparatus of claim 14, wherein the processor is further configured to provide a query to the user of whether to delete the at least one downloaded and consumed episode, and download the at least one episode of the selected plurality of episodes not yet downloaded, if a user response to the query is yes.

16. The apparatus of claim 15 wherein the processor is configured to skip the downloading of the at least one episode of the selected plurality of episodes not yet downloaded, If the user response to the query is no.

17. The apparatus of claim 11 wherein the processor is further configured to determine a number of episodes of the show to be downloaded based on a user profile.

18. The apparatus of claim 17, wherein the number of the episodes to be downloaded is determined in response to a message from the server indicating that all episodes of the show are available for download.

19. The apparatus of claim 18 wherein the all episodes correspond to a season of the show.

20. A method for use on a website for downloading episodes of a show to a user device, the method comprising:
determining a plurality of episodes of a show to be downloaded in response to a user request from the user device;
determining if there is sufficient space in a storage device for the selected plurality of episodes of the show;
and
if sufficient space is not available for the determined plurality of episodes of the show as determined by the determining, then instructing the user device to delete at least one downloaded and consumed episode of same show from the storage device, and downloading at least one episode of the selected plurality of episodes not yet downloaded.

21. A computer program product stored in non-transitory computer-readable storage media comprising computer-executable instructions for:
selecting a plurality of episodes of a show for download from a server;
determining if there is sufficient space in a storage device for the selected plurality of episodes of the show;
and
if sufficient space is not available for the selected plurality of episodes of the show as determined by the determining, then deleting at least one downloaded and consumed episode of same show from the storage device, and downloading at least one episode of the selected plurality of episodes not yet downloaded.
